(19) United States
(12) Patent Application Publication
(10) Pub. No.: US 2024/0394478 A1
(43) Pub. Date: Nov. 28, 2024

(54) METHOD FOR SAMPLE GENERATION, COMPUTER DEVICE, AND STORAGE MEDIUM

(71) Applicant: Beijing Volcano Engine Technology Co., Ltd., Beijing (CN)

(72) Inventors: Wenqi XIE, Beijing (CN); Zhaosha FAN, Beijing (CN); Xiaodong SU, Beijing (CN); Minglei LI, Beijing (CN)

(21) Appl. No.: 18/671,690

(22) Filed: May 22, 2024

(30) Foreign Application Priority Data
May 22, 2023 (CN) 202310580012.5

(51) Int. Cl. G06F 40/30; G06F 16/33; G06F 40/174; G06F 40/186

(52) U.S. Cl. CPC G06F 40/30; G06F 16/3331; G06F 40/174; G06F 40/186

(57) ABSTRACT

A method and apparatus for sample generation, a method and apparatus for information detection, a computer device, and a storage medium are provided, and the method for sample generation includes: acquiring a reference data set, where the reference data set includes first reference data and second reference data, the first reference data includes at least one information sample value, the information sample value belongs to a target information type, and the second reference data does not include an information sample value of the target information type; determining a target template corresponding to the first reference data based on the at least one information sample value in the first reference data; generating a plurality of sample information based on the target template corresponding to the first reference data; and generating a sample data set based on the plurality of sample information and the second reference data.

### CROSS-REFERENCE TO RELATED APPLICATION

This application claims the priority to and benefits of the Chinese Patent Application, No. 202310580012.5, which was filed on May 22, 2023. The aforementioned patent application is hereby incorporated by reference in its entirety.

### TECHNICAL FIELD

The present disclosure relates to the field of computer technology, in particular, to a method and apparatus for sample generation, a method and apparatus for information detection, a computer device, and a storage medium.

### BACKGROUND

With the development of science and technology, data security has become the focus of current society, so how to accurately and efficiently detect specific data with security requirements from a large number of data has become an important research content in the field of data security.

In general, a specific data detection model can be used to realize a specific data detection task, which requires that all specific information contained in the input data, specific data types, specific data sample values, index positions of specific data, etc. are identified for a given input data. It can be seen that the accuracy of specific data detection model is particularly important, and the accuracy of specific data detection model is closely related to the sample data set used in training.

### SUMMARY

At least one embodiment of the present disclosure provides a method and apparatus for sample generation, a method and apparatus for information detection, a computer device, and a storage medium.

At least one embodiment of the present disclosure provides a method for sample generation, which includes:
acquiring a reference data set, where the reference data set includes first reference data and second reference data, the first reference data includes at least one information sample value, the at least one information sample value belongs to a target information type, the target information type is a preset information type with a security requirement, and the second reference data does not include an information sample value of the target information type;
determining a target template corresponding to the first reference data based on the at least one information sample value in the first reference data, the target template being used to characterize an information structure of the at least one information sample value in the first reference data;
generating a plurality of sample information based on the target template corresponding to the first reference data; and
generating a sample data set based on the plurality of sample information and the second reference data.

In an optional implementation, determining a target template corresponding to the first reference data based on the at least one information sample value in the first reference data includes:
analyzing the at least one information sample value in the first reference data to determine a keyword list corresponding to the at least one information sample value;
according to index information of the at least one information sample value in the first reference data, and index information of each keyword in the keyword list corresponding to the at least one information sample value in the first reference data, determining an information template of the at least one information sample value; and
generating a target template corresponding to the first reference data based on the information template of the at least one information sample value.

In an optional implementation, analyzing the at least one information sample value in the first reference data to determine a keyword list corresponding to the at least one information sample value includes:
determining a search interval corresponding to the at least one information sample value based on index information of the at least one information sample value in the first reference data and a set search length threshold; and
determining a keyword list corresponding to the at least one information sample value from the search interval corresponding to the at least one information sample value using a preset word library matching a target information type to which the at least one information sample value belongs.

In an optional implementation, the preset word library matching the target information type is generated according to following steps:
based on a target semantic indicated by the target information type, acquiring a target word of the target semantic;
based on the target word, generating a compound word including the target word;
based on the target word, constructing a misspelled word of the target word; and
based on the target word, the compound word and the misspelled word, generating the preset word library matching the target information type.

In an optional implementation, when the first reference data includes a plurality of information sample values, generating a target template corresponding to the first reference data based on the information template of the at least one information sample value includes:
based on index information of each of a plurality of information templates in the first reference data, sorting the plurality of information templates; and
according to a preset gap threshold, performing merging processing on a sorted plurality of information templates to generate a target template corresponding to the first reference data.

In an optional implementation, according to a preset gap threshold, performing merging processing on the sorted plurality of information templates to generate a target template corresponding to the first reference data includes:
based on index information of the plurality of information templates in the first reference data, determining a gap length between every two adjacent information templates in the sorted plurality of information templates;
performing merging processing on a plurality of information templates with a gap length smaller than the preset gap threshold to generate a processed information template; and
when an unprocessed information template exists in the plurality of information templates, generating a target template corresponding to the first reference data based on the processed information template and the unprocessed information template.

In an optional implementation, when the target template includes an information sample value, a keyword, and background information, generating a plurality of sample information based on the target template corresponding to the first reference data includes:
generating replacement information corresponding to the target template, the replacement information including at least one of a sample replacement value corresponding to the information sample value, a replacement word corresponding to the keyword, and a replacement background corresponding to the background information; and
based on the replacement information, performing a replacement operation on the target template to generate a plurality of sample information.

In an optional implementation, generating replacement information corresponding to the target template includes:
when the replacement information includes the sample replacement value corresponding to the information sample value, based on the information sample value included in the target template, constructing a regular expression satisfying a composition form of the information sample value; and based on the regular expression, generating the sample replacement value;
when the replacement information includes the replacement word corresponding to the keyword, acquiring the replacement word corresponding to the keyword from the keyword library of a target information type corresponding to the keyword, the keyword library being constructed by finding keywords from the first reference data based on semantic information indicated by the target information type; and
when the replacement information includes the replacement background corresponding to the background information, for each character included in the background information, determining a replacement character corresponding to the character based on a determined character matching condition, and generating the replacement background corresponding to the background information based on each replacement character.

In an optional implementation, generating a sample data set based on the plurality of sample information and the second reference data includes:
for each of the second reference data, determining an insertion scheme of the second reference data based on a set proportional parameter and a random number generated for the second reference data, the insertion scheme including inserting sample information and not inserting sample information;
when the insertion scheme of the second reference data is inserting sample information, inserting at least one sample information into the second reference data to generate sample data; and
generating the sample data set based on the sample data and second reference data with no sample information inserted.

In an optional implementation, inserting at least one sample information into the second reference data to generate sample data includes:
determining a sample quantity and an insertion position corresponding to the second reference data;
inserting the sample quantity of sample information into the insertion position of the second reference data to generate updated second reference data, and determining labeling information of the updated second reference data, the labeling information including a target information type, an information sample value, a starting index position of the information sample value in the updated second reference data, a length of the information sample value; and
determining the updated second reference data including the labeling information as sample data.

At least one embodiment of the present disclosure further provides a method for information detection, which includes:
detecting information content included in data to be detected by using an information detection model to obtain a detection result corresponding to the data to be detected; and
when the detection result indicates that the data to be detected includes target information belonging to a target information type, generating prompt information,
where the information detection model is trained by using a sample data set, and the sample data set is generated according to the method for sample generation provided by at least one embodiment of the present disclosure.

At least one embodiment of the present disclosure further provides an apparatus for sample generation, which includes:
an acquisition module, configured to acquire a reference data set, where the reference data set includes first reference data and second reference data, the first reference data includes at least one information sample value, the at least one information sample value belongs to a target information type, the target information type is a preset information type with a security requirement, and the second reference data does not include an information sample value of the target information type;
a determination module, configured to determine a target template corresponding to the first reference data based on the at least one information sample value in the first reference data, the target template being used to characterize an information structure of the at least one information sample value in the first reference data;
a first generation module, configured to generate a plurality of sample information based on the target template corresponding to the first reference data; and
a second generation module, configured to generate a sample data set based on the plurality of sample information and the second reference data.

At least one embodiment of the present disclosure further provides an apparatus for information detection, which includes:
a detection module, configured to detect information content included in data to be detected by using an information detection model to obtain a detection result corresponding to the data to be detected; and
a third generation module, configured to, when the detection result indicates that the data to be detected includes target information belonging to a target information type, generate prompt information,
where the information detection model is trained by using a sample data set, and the sample data set is generated according to the method for sample generation provided by at least one embodiment of the present disclosure.

At least one embodiment of the present disclosure further provides a computer device, which includes: at least one processor, a memory and a bus, where the memory stores machine-readable instructions executable by the at least one processor; the at least one processor communicates with the memory through the bus upon running of the computer device, and the machine-readable instructions, upon being executed by the at least one processor, execute the method for sample generation or the method for information detection according to at least one of the above embodiments of the present disclosure.

At least one embodiment of the present disclosure further provides a non-transient computer-readable storage medium which stores computer programs, the computer programs, upon being run by at least one processor, executing the method for sample generation or the method for information detection according to at least one of the above embodiments of the present disclosure.

In order to make the aforementioned objects, features and advantages of the present disclosure more comprehensible, embodiments accompanied with the drawings are described in detail below.

### BRIEF DESCRIPTION OF DRAWINGS

To more clearly illustrate the embodiments of the present disclosure, the drawings required to be used for the embodiments are briefly described in the following. The drawings herein are incorporated into and form a part of the specification, illustrate embodiments consistent with the present disclosure, and are used in conjunction with the specification to explain the principles of the present disclosure. It should be understood that are only some embodiments of the present disclosure, and therefore should not be regarded as limiting the scope. For those skilled in the art, other drawings can be obtained based on these drawings without any inventive work.

FIG. 1 shows a flowchart of a method for sample generation provided by an embodiment of the present disclosure;

FIG. 2 shows a flowchart of another method for sample generation provided by an embodiment of the present disclosure;

FIG. 3 shows a flowchart of a method for information detection provided by an embodiment of the present disclosure;

FIG. 4 shows a schematic diagram of an apparatus for sample generation provided by an embodiment of the present disclosure;

FIG. 5 shows a schematic diagram of an apparatus for information detection provided by an embodiment of the present disclosure;

FIG. 6 shows a structural schematic diagram of a computer device provided by an embodiment of the present disclosure.

### DETAILED DESCRIPTION

To make the objects, technical solutions and advantages of the present disclosure clearer, the technical solutions of the embodiments of the present disclosure will be described clearly and fully understandable in conjunction with the drawings related to the embodiments of the present disclosure. Apparently, the described embodiments are just a part but not all of the embodiments of the present disclosure. The components in the embodiments of the present disclosure generally described and illustrated in the drawings herein may be arranged and designed in various different configurations. Therefore, the following detailed description of the embodiments of the present disclosure provided in the accompanying drawings is not intended to limit the scope of the claimed disclosure, but merely represents selected embodiments of the present disclosure. Based on the described embodiments herein, those skilled in the art can obtain other embodiment(s), without any inventive work, which should be within the scope of the present disclosure.

General data can be divided into structured data and unstructured data according to the carrier form. Structured data is generally stored in a database, and specific data detection can be directly performed through the precise definition of metadata. Because of the variety of data formats of unstructured data, such as relying solely on traditional rules such as keywords to detect specific data, there is a lack of context semantic level analysis, which leads to inaccurate detection of specific data. Therefore, the specific data detection task may be realized by using the specific data detection model. The specific data detection task requires identifying all the specific information contained in the input data, detecting the specific data type, the specific data sample value, the index position of the specific data, etc. for a given input data. It can be seen that the accuracy of specific data detection model is particularly important, and the accuracy of specific data detection model is closely related to the sample data set used in training.

It is found that the sample data set used for specific data detection is difficult to obtain, on the one hand, the original specific data is difficult to obtain. Specifically, in order to protect information security and reduce the risk of specific data leakage, the data provider will not provide a large number of specific data to the third party for model training, which makes the sample size of data available to the third party not meet the demand. On the other hand, it is difficult to quantify the specific data labeling level. Because of the specificity of data, the data labeling work needs the data project specialist to label the specific data, which cannot be leaked to other personnel for labeling. The data labeling efficiency is low, and the standards of specific data in different business scenarios are different, and there are many specific types. When manual labeling scheme is adopted, the labeling cost is high. Therefore, how to construct a sample data set with high efficiency and low cost for training a specific data detection model is an urgent problem to be solved.

Based on the above studies, the present disclosure provides a method for sample generation, by acquiring a reference data set, a target template corresponding to the first reference data can be determined to be obtained based on the at least one information sample value in the first reference data because the first reference data includes at least one information sample value that belongs to a target information type, the target information type being a preset information type with a security requirement. Further, based on the target template included in the first reference data, a plurality of sample information can be generated more simply and efficiently; and then based on the plurality of sample information and the second reference data, a sample data set can be generated, which improves the efficiency of constructing the sample data set.

After obtaining the target template, a plurality of sample information is constructed by the target template, the construction of the sample data set using a small amount of the first reference data is achieved. And because the target template is capable of characterizing the information structure of the at least one information sample value in the first reference data, the label information of the target template is determined, and thus the labeling information of the plurality of sample information is readily available when the plurality of sample information is generated based on the target template, so that the labeling information of each sample data in the sample data set is readily available, and the problems of data leakage, high cost, and low efficiency caused by manual labeling in the related art are alleviated.

It should be noted that like reference numbers and letters refer to like items in the following drawings, and thus, once an item is defined in one drawing, it need not be further defined or explained in subsequent drawings.

The term “and/or” herein merely describes an associative relationship, meaning the presence of three relationships; for example, A and/or B may mean that A exists alone, A and B exist simultaneously, and B exists alone. In addition, the term “at least one” herein means any one of a plurality of elements or any combination of at least two of a plurality of elements, for example, including at least one of A, B, C may mean including any one or more elements selected from the group consisting of A, B and C.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

For example, in response to receiving an active request from a user, prompt information is sent to the user to clearly prompt the user that an operation requested by the user to be performed will require acquisition and use of personal information of the user. Therefore, the user can independently choose whether to provide personal information to software or hardware such as a computer device, an application program, a server or a storage medium that performs the operations of the technical solution of the present disclosure according to the prompt information.

As an optional but non-limiting implementation, in response to receiving the active request of the user, the prompt information may be sent to the user by, for example, a pop-up window, in which the prompt information can be presented in the form of text. In addition, the pop-up window can also carry a selection control for the user to choose “agree” or “disagree” to provide personal information to the computer device.

It can be understood that the above process of notifying and acquiring user authorization is only schematic, and does not limit the implementation of the present disclosure, and other ways meeting relevant laws and regulations may also be applied to the implementation of the present disclosure.

In order to facilitate understanding of the present embodiment, firstly, a method for sample generation disclosed in the present embodiment of the disclosure is introduced in detail. The execution subject of the method for sample generation provided in embodiments of the present disclosure is generally a computer device with certain computing power, which includes, for example, a terminal device or a server or other processing device, and the terminal device may be a user equipment (UE), a mobile device, a user terminal, a computing device, etc. In some possible implementations, the method for sample generation may be realized by a processor calling computer-readable instructions stored in a memory

The method for sample generation provided by embodiments of the present disclosure will be described below by taking the execution subject as the server as an example.

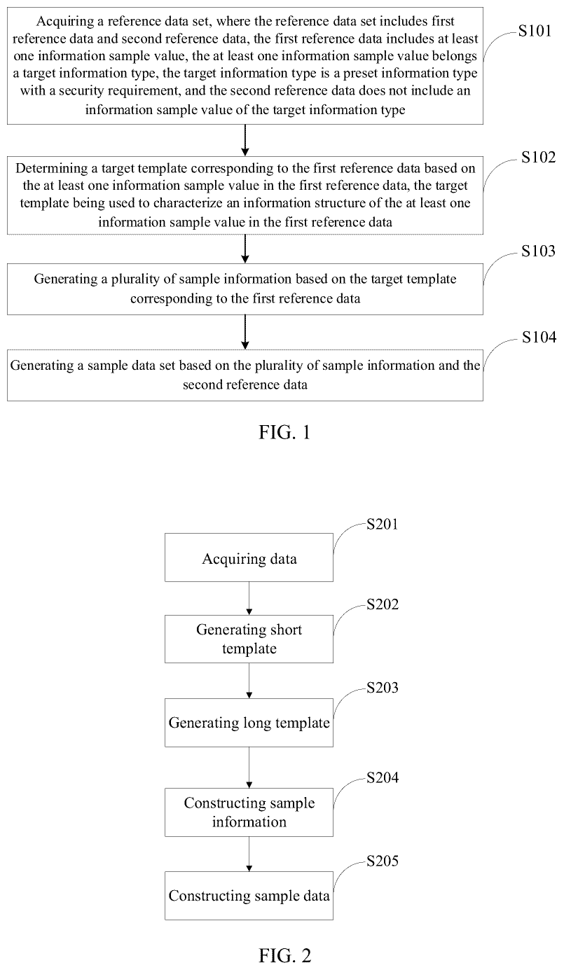

Referring to FIG. 1, FIG. 1 is a flowchart of a method for sample generation provided by an embodiment of the present disclosure, and the method includes S101˜S104.

S101, acquiring a reference data set, where the reference data set includes first reference data and second reference data, the first reference data includes at least one information sample value, the information sample value belongs to a target information type, the target information type is a preset information type with a security requirement, and the second reference data does not include an information sample value of the target information type.

S102, determining a target template corresponding to the first reference data based on the at least one information sample value in the first reference data, the target template being used to characterize an information structure of the at least one information sample value in the first reference data.

S103, generating a plurality of sample information based on the target template corresponding to the first reference data.

S104, generating a sample data set based on the plurality of sample information and the second reference data.

S101-S104 will be specifically described below, respectively.

For S101,
the reference data set includes at least one first reference data and at least one second reference data, where the first reference data includes at least one information sample value, the information sample value belongs to a target information type, the target information type is a preset information type with a security requirement, the information type with a security requirement may be set according to a business requirement. For example, a specific information type may be determined as an information type with a security requirement, for example, a name type, a phone type, an address type, a mail type, etc. Alternatively, a company type, a gender type, and the like may also be included.

The first reference data and the second reference data may be unstructured data, the first reference data and the second reference data may be business log data, natural text data, buried data, and the like. The information sample value may be an entity content of the target information type, for example, the information sample value of the name type may be “Wang xx”, and the information sample value of the phone type may be “133xxxx1111”, etc. One or more information sample values may be included in the first reference data, a plurality of the information sample values may belong to the same target information type or to different target information types. The acquired first reference data is associated with labeling information including a target information type to which the information sample value belongs, the information sample value, a starting index position of the information sample value in the first reference data, a length of the information sample value, and the like.

Taking the first reference data as the business log data as an example, the first reference data may include, for example, “\“agency_id\”:6664800aaabb0658823,\“real_name\”:\“Zhu*qiang\”,\“phone\”:\“133****111 1\”,\“encrypt_phone\”:\“#1ovL/IADQC9FC0iCuZxGXwvBMFE0pdq70Xd1hROG1lcE4xIM Elfm\”,\“Email\”:\“aaaaa_email.sample-7527@juli.com\”,\“Addr\”:\“bb City xx District xxxx Park Building 1 Floor 2 0000\”,\“company\”:\“Beijing xxxxxx Co. Ltd.\””. It may be analyzed that information sample values included in the first reference data are “Zhu*qiang”, “133****1111”, “aaaaa_email.sample-7527@juli.com”, “bb City xx District xxxx Park Building 1 Floor 2 0000”.

For S102,
after acquiring the one or more first reference data, each first reference data may be analyzed to obtain a target template corresponding to each first reference data, the target template is used to characterize an information structure of at least one information sample value in the first reference data. For example, when there are a plurality of information sample values, the target template may include a short template of each information sample value respectively in the first reference data, or may include a long template of a plurality of information sample values in the first reference data. The short template is used to characterize an individual information structure of the information sample value in the first reference data. The long template is used to characterize the overall information structure of the plurality of information sample values in the first reference data.

In an alternative embodiment, determining a target template corresponding to the first reference data based on the at least one information sample value in the first reference data includes steps a1˜a3.

Step a1, analyzing the at least one information sample value in the first reference data to determine a keyword list corresponding to the at least one information sample value.

Step a2, according to index information of the at least one information sample value in the first reference data, and index information of each keyword in the keyword list corresponding to the at least one information sample value in the first reference data, determining an information template of the at least one information sample value.

Step a3, generating a target template corresponding to the first reference data based on the information template of the information sample value.

The present disclosure determines a keyword list of the information sample value by analyzing the information sample value, determining an information template of the information sample value according to the index information of the information sample value in the first reference data, and the index information of each keyword in the keyword list corresponding to the information sample value in the first reference data. Because the keyword can provide a semantic indication for the determination of the target information type of the information sample value, the obtained information template of the information sample value is made more accurate and complete, so as to subsequently generate the target template included in the first reference data more accurately

In step a1, the information sample value in the first reference data is analyzed to determine the keyword list corresponding to the information sample value. The keyword list includes at least one keyword that play the role of semantic indication for the determination of the target information type of the information sample value, i.e., the keyword is a word having an explicit indication of the target information type of the information sample value in the context of the information sample value. For example, when analyzing the information sample value “133****1111” in the above example, it can be seen that the terms “phone” and “encrypt_phone” play the role of semantic indication for the target information type of the information sample value, so the keywords “phone” and “encrypt_phone” are included in the list of keywords corresponding to the information sample value.

In an alternative embodiment, in the step a1, analyzing the information sample value in the first reference data to determine a keyword list corresponding to the information sample value includes steps a11˜a12.

Step a11, determining a search interval corresponding to the at least one information sample value based on index information of the at least one information sample value in the first reference data and a set search length threshold.

Step a12, determining a keyword list corresponding to the at least one information sample value from the search interval corresponding to the information sample value using a preset word library matching a target information type to which the at least one information sample value belongs.

Considering that the keyword corresponding to the information sample value is generally located in the vicinity of information sample value, in order to more accurately and efficiently determine the keyword category of the information sample value, a search interval corresponding to the information sample value may first be determined based on index information of each information sample value in the first reference data and a set search length threshold. The index information of the information sample value in the first reference data may for example include a start index position and an end index position of the information sample value in the first reference data, or may include a start index position and a length of the information sample value in the first reference data. For example, for the case of the first reference data mentioned at S101, the index information of the first information sample value “133****1111” includes: a start index position of 59, and a length of 11.

The search length threshold may be set according to the actual situation, for example, an above search length threshold and a below search length threshold may be set, and then the search interval may be determined based on the above search length threshold, the below search length threshold, and the index information of the information sample value. Specifically, the search interval may be: [index_i−above_search_threshold, index_i+length_i+below_search_threshold], where index_i is the starting index position of the information sample value, above_search_threshold is the above search length threshold, length_i is the length of the information sample value, and below_search_threshold is the below search length threshold.

For example, when the above search length threshold and the below search length threshold are both 50, the search index range corresponding to the first information sample value “133****1111” is [9-120], and the search interval in the first reference data within the search index range is determined to be: “d\“:6664800aaabb0658823,\“real_name\”:\“Zhu*qiang\”,\“phone\”:\“133****1111\”,\“encry pt_phone\”:\“#1ovL/IADQC9FC0iCuZxGXwvBMFE0pd”. Similarly, the search interval corresponding to each information sample value in the first reference data can be obtained according to the above-described method.

In step a12, each target information type corresponds to a preset word library, and the preset word library stores a plurality of preset words that match the semantic of the target information type. For example, when the target information type is a mailbox information type, the preset library may include mailbox, mail, Email, and the like.

In an alternative embodiment, for each target information type, the preset word library matching the target information type is generated according to following steps: based on a target semantic indicated by the target information type, acquiring a target word of the target semantic; based on the target word, generating a compound word including the target word; based on the target word, constructing a misspelled word of the target word; and based on the target word, the compound word and the misspelled word, generating the preset word library matching the target information type.

For each target information type, the target word of the target semantic, such as the phone information type, may be acquired based on the target semantic indicated by the target information type, and the obtained target word may include, but is not limited to: mob, tel, number, phone, line, contact, and the like. A compound word containing the target word may then be generated based on the target word, such as the compound word including contact_phone, telnumber, and the like. And a misspelled word of the target word may be constructed based on the target word, such as telphnoe, nunber, and the like. A plurality of compound words and misspelled words may be generated based on the target word according to prior knowledge such as historical writing experience, writing specifications, and the like.

Further, the target word, the compound words and the misspelled words are used as preset words, and a preset word library matching the target information type is constructed.

After the target word is determined, compound words and misspelled words may be generated based on the target word, the word information of the predicted word library is enriched, so that the keyword list corresponding to each information sample value can be determined more comprehensively and accurately according to the preset word library, and precise positioning of the keywords is achieved.

Further, the search interval corresponding to the information sample value may be traversed using the preset word library matching the target information type to which the information sample value belongs, and a keyword matching any one of the preset words in the preset word library within the search interval may be determined, and a keyword list corresponding to the information sample value may be obtained. For example, the search interval mentioned the in above case is: d\“:6664800aaabb0658823,\“real_name\”:\“Zhu*qiang\”,\“phone\”:\“133****1111\”,\“encryp t_phone\”:\“#1ovL/IADQC9FC0iCuZxGXwvBMFE0pd”, and the information sample value “133****1111” corresponds to a keyword list includes a keyword “phone” and a keyword “encrypt phone”.

By determining the search interval of the information sample value, the keyword search range is narrowed, and the keyword list corresponding to the information sample value is determined from the search interval corresponding to the information sample value using the preset word library matching the target information type to which the information sample value belongs, and the determination efficiency and the determination accuracy of the keyword list are improved.

In step a2, after the keyword list corresponding to the information sample value is obtained, for each information sample value, a template index interval where the information sample value is located may be determined according to the index information of the information sample value in the first reference data, and the index information of each keyword in the keyword list corresponding to the information sample value in the first reference data. For example, for an information sample value of “133****1111” in the above example, the information sample value corresponds to index information includes a start index position of 59 and a length of 11. The index information of the keyword “phone” in the keyword list includes a start index position of 51 and a length of 5. The index information of the keyword “encrypt_phone” includes a start index position of 73 and a length of 13. The template index interval may be obtained by taking the intersection of the sample information value and the position of each keyword in the keyword list in the first reference data. For example, the sample information value is at position 59-70 in the first reference data, the keyword “phone” is at position 51-56 in the first reference data, and the keyword “encrypt_phone” is at position 73-86 in the first reference data, and the template index interval determined by the analysis is [51-86]. Based on the template index interval, a minimum short template may be obtained, i.e. “phone\”:\“133****1111\”,\“encrypt_phone”.

In order to guarantee the integrity of the template, i.e., ensure the integrity of the keyword and the information sample value, after the minimum short template is obtained, the minimum short template may be completed, resulting in a complete short template, and the complete short template is determined as the information template of the information sample value. For example, a forward search may be performed based on the minimum short template to determine a first delimiter closest to the first character of the minimum short template, and a backward search may be performed based on the minimum short template to determine a second delimiter closest to the last character of the minimum short template. Based on the first delimiter and the second delimiter, it is determined that a complete short template of the information sample value is obtained, i.e., the short template interval is [forward_sep_index+1, backward_sep_index], where forward_sep_index is an index position of the first delimiter in the first reference data and backward_sep_index is an index position of the second delimiter in the first reference data. The delimiter may be determined based on the actual situation, for example, the delimiter includes, but not limited to: [“;”, “,”, “\n”, “\t”, “&”, “[”, “{”, “<”, “:”].

Continuing with the above example, the above example illustrates that the resulting minimum short template is “phone\”:\“133****9757\”,\“encrypt_phone”, and the complete short template (i.e., the information template of the information sample value) obtained by completing the minimum short template is “\“phone\”:\“133****1111\”,\“encrypt_phone\””.

The information template of the information sample value may be recorded in the form of a dictionary, and for example, the information template may include a target information type, a short template interval, a keyword list, an information sample value, and a keyword-sample value co-occurrence pattern. Taking the information template corresponding to the above information sample value “133****1111” as an example, the information template may include: the target information type: “phone information type”; the short template interval: “\“phone\”:\“133****1111\”,\“encrypt_phone\””; the keyword list: keyword “phone”, index position 51; keyword “encrypt phone”, index position 73; the information sample value: “133****1111\”, starting index position 59; the keyword-sample value co-occurrence pattern: “\“\”:\“\”,\“\””, index position of the keywords on co-occurrence pattern [1, 7], index position of the information sample value on co-occurrence pattern [4].

In step a3, after obtaining the information template corresponding to each information sample value, the information template corresponding to each information sample value may be determined as the target template included in the first reference data, or the information templates corresponding to a plurality of information sample values may be merged, and the merged information template may be determined as the target template included in the first reference data.

In an alternative embodiment, in step a3, when the first reference data includes a plurality of information sample values, generating a target template corresponding to the first reference data based on the information template of the information sample value includes steps a31-a32.

Step a31, based on index information of each information template in the first reference data, sorting the plurality of information templates.

Step a32, according to a preset gap threshold, performing merging processing on a sorted plurality of information templates to generate a target template corresponding to the first reference data.

In embodiments of the present disclosure, because a plurality of information sample values are included in the first reference data, an information template may be obtained for each information sample value, and a plurality of information templates respectively corresponding to the plurality of information sample value are obtained in step a2. The plurality of information templates are sorted according to the index information of each information template in the first reference data. For example, the plurality of information templates may be sorted in order of the index information from small to large to obtain a sorted plurality of information templates. And merging the sorted plurality of information templates according to a preset gap threshold, thereby generating a target template included in the first reference data. A preset gap threshold may be set for the plurality of first reference data, or a preset gap threshold may be set for each first reference data.

The preset gap threshold may be used to determine whether two adjacent information templates can be merged. For example, if the gap between the two adjacent information templates is larger than the preset gap threshold, it is characterized that more background information is included between the two information templates. If the two information templates are merged and the resulting target template includes more background information, there is background interference to the subsequent generation of the sample information. Therefore, by setting the preset gap threshold, the target template included in the first reference data can be more accurately obtained.

In an alternative embodiment, in step a32, according to a preset gap threshold, performing merging processing on the sorted plurality of information templates to generate a target template corresponding to the first reference data includes: based on index information of the plurality of information templates in the first reference data, determining a gap length between every two adjacent information templates in the sorted plurality of information templates; performing merging processing on a plurality of information templates with a gap length smaller than the preset gap threshold to generate a processed information template; and when an unprocessed information template exists in the plurality of information templates, generating a target template corresponding to the first reference data based on the processed information template and the unprocessed information template.

In the present disclosure, based on the index information of each information template in the first reference data, a gap length between every two adjacent information templates in the sorted plurality of information templates is determined. For example, for the first reference data mentioned in S101, which includes 4 sample information values, namely “Zhu*qiang”, “133****1111”, “aaaaa_email.sample-7527@juli.com”, and “bb City xx District xxxx Park Building 1 Floor 2 0000”, for each information sample value, an information template may be obtained, resulting in 4 information templates sorted, including: an information template 1: “\“real_name\”:\“Zhu*qiang\””; an information template 2: ““phone\”:\“133****1111\”,\“encrypt_phone””; an information template 3: “\“Email\”:\“aaaa_email.sample-7527@juli.com\””; and an information template 4: “\“Addr\”:\“bb City xx District xxxx Park Building 1 Floor 2 0000\””.

If the preset gap threshold is set as any of [1-57), the gap length between the information template 1 and the information template 2 is smaller than the preset gap threshold, the gap length between the information template 2 and the information template 3 is larger than the preset gap threshold, and the gap length between the information template 3 and the information template 4 is smaller than the preset gap threshold, so that the information template 1 and the information template 2 may be merged, the information template 3 and the information template 4 may be merged, and two target templates are obtained. That is, the resulting target template includes a target template 1: “\“real_name\”:\“Zhu*qiang\”,\“phone\”:\“133****1111\”,\“encrypt_phone\””, and a target template 2: “\“Email\”:\“aaaaa_email.sample-7527@juli.com\”,\“Addr\”:\“bb City xx District xxxx Park Building 1 Floor 2 0000\””.

If the preset gap threshold is set to be a positive integer greater than or equal to 57, it is determined that the gap length between any two adjacent information templates among the four information templates of the first reference data is less than the preset gap threshold, and the four information templates may be subjected to a merging process to obtain a target template. That is, the resulting target template is “\“real_name\”:\“Zhu*qiang\”,\“phone\”:\“133****1111\”,\“encrypt_phone\”:\“#1ovL/IADQ C9FC0iCuZxGXwvBMFE0pdq70Xd1hROG1lcE4xIMElfm\”,\“Email\”:\“aaaaa_email.sampl e-7527@juli.com\”,\“Addr\”:\“bb City xx District xxxx Park Building 1 Floor 2 0000\””.

The target template may be recorded in the form of a dictionary, for example, the target template may include a target information type, a long template interval, a keyword list, a list of information sample values, and a multi-sample co-occurrence pattern. Taking the target template obtained above as an example, the target template includes the following:
target information type: [‘real_name’, ‘mobile’, ‘email’, ‘address’];
keyword list: [{keyword: “real_name”, index position: 33}; {keyword: “phone”, index position: 51}; {keyword: “encrypt_phone”, index position: 73}; {keyword: “Email”, index position: 145}; {keyword: “Addr”, index position: 188}];
information sample value list: [{information sample value: “Zhu*qiang”, index position: 45}; {information sample value: “133****1111”, index position: 59}; {information sample value: “aaaaa_email.sample-7527@juli.com”, index position: 153}; {information sample value: “bb City xx District xxxx Park Building 1 Floor 2 0000”, index position: 195}];
long template interval: {long template content: “\“real_name\”:\“Zhu*qiang\”,\“phone\”:\“133****1111\”,\“encrypt_phone\””, and target template 2: “\“Email\”:\“aaaaa_email.sample-7527@juli.com\”,\“Addr\”:\” bb City xx District xxxx Park Building 1 Floor 2 0000\””; index position: 32}; and
multi-sample co-occurrence pattern: {co-occurrence pattern: “\“\”:\“\”\“\”:\“\”,\“\”:\“#1ovL/IADQC9FC0iCuZxGXwvBMFE0pdq70Xd1hROG1lcE4xIM Elfm\”,\“\”:\“\”,\“\”:\“\””; index position of each keyword in the co-occurrence pattern: [1,7,13,72,78]; index position of information sample values in the co-occurrence pattern: [4,10,75,81]}.

After obtaining the target template, the labeling information of the target template in the first reference data may also be determined and saved.

For S103,
after the target template is obtained, an imitation may be performed based on the target template included in the first reference data to obtain a plurality of sample information matching the template structure of the target template. For example, if the target template includes an information sample value, an imitation may be performed based on the information sample value to obtain a new information sample value, and the new information sample value is used to replace the original information sample value to generate a sample information.

In an alternative embodiment, when the target template includes an information sample value, a keyword, and background information, generating a plurality of sample information based on the target template corresponding to the first reference data includes steps b1˜b2.

Step b1, generating replacement information corresponding to the target template, the replacement information including at least one of a sample replacement value corresponding to the information sample value, a replacement word corresponding to the keyword, and a replacement background corresponding to the background information.

Step b2, based on the replacement information, performing a replacement operation on the target template to generate a plurality of sample information.

By generating the replacement information corresponding to the target template and performing the replacement operation on the target template using the replacement information, a plurality of sample information can be easily obtained so that the sample data can be subsequently constructed using the plurality of sample information. The purpose of generating a large amount of sample data using a small amount of first reference data is achieved, and the construction efficiency of the sample data is improved.

In step b1, when the target template includes an information sample value, a keyword and background information, a sample replacement value corresponding to the information sample value, a replacement word corresponding to the keyword, a replacement background corresponding to the background information may be generated. For example, for the target template: “\“real_name\”:\“Zhu*qiang\”,\“phone\”:\“133****1111\”,\“encrypt_phone\”:\“#1ovL/IADQ C9FC0iCuZxGXwvBMFE0pdq70Xd1hROG1lcE4xIMElfm\”,\“Email\”:\“aaaaa_email.sampl e-7527@juli.com\”,\“Addr\”:\“bb City xx District xxxx Park Building 1 Floor 2 0000\””, the target template includes information sample values “Zhu*qiang”, “133****1111”, “aaaaa_email.sample-7527@juli.com\”, ““bb City xx District xxxx Park Building 1 Floor 2 0000”. And the target template includes keywords “real_name”, “phone”, “encrypt_phone”, “Email”, “Addr”. And the target template further includes background information “#1ovL/IADQC9FC0iCuZxGXwvBMFE0pdq70Xd1hROG1lcE4xIMElfm”.

In practice, string imitation may be used to generate the replacement information, for example: for the information sample value “133****1111”, the first character “1” can match any number in the number 1-9, so the imitation may be performed to get the number “1” corresponding to the replacement character “2”, the second character “3” can match any number in the number 1-9, so the imitation may be performed to get the number “3” corresponding to the replacement character “5”, and in turn for the imitation of the character, a plurality of replacement characters may be obtained, and the plurality of replacement characters constitute the sample replacement value corresponding to the information sample value.

In an alternative embodiment, in step b1, generating replacement information corresponding to the target template specifically includes steps b11˜b13.

Step b11, when the replacement information includes the sample replacement value corresponding to the information sample value, based on the information sample value included in the target template, constructing a regular expression satisfying a composition form of the information sample value; and based on the regular expression, generating the sample replacement value.

Step b12, when the replacement information includes the replacement word corresponding to the keyword, acquiring the replacement word corresponding to the keyword from the keyword library of a target information type corresponding to the keyword, the keyword library being constructed by finding keywords from the first reference data based on semantic information indicated by the target information type.

Step b13, when the replacement information includes the replacement background corresponding to the background information, for each character included in the background information, determining a replacement character corresponding to the character based on a determined character matching condition, and generating the replacement background corresponding to the background information based on each replacement character.

In step b11, a plurality of sample replacement values may be generated in a manner using a random construction. For example, by analyzing the sample information value, a composition form of the sample information value is obtained, and according to the composition form, a regular expression is constructed so that the randomly generated sample replacement value can cover the composition form of the information sample value of a plurality of application scenarios. For example, for “133****1111”, it can be analyzed that a mobile phone is generally 11 bits and the first bit is 1, so that the regular expression “1(3\d|4[5-9]|5[0-35-9]|6[2567]|7[0-8]|8\d|9[0-35-9])\d{8}” may be designed, and a plurality of sample replacement values may be generated based on the regular expression.

For another example, wildcards and exact characters may be set, and according to the composition form of the information sample value, the wildcards and exact characters are randomly spliced to obtain a regular expression, so that a plurality of sample replacement values may be generated based on the regular expression subsequently. The wildcards and exact characters may be set as desired, for example, the wildcards may include “[a-z], [A-Z], [0-9]”, or the range of the interval may be extended, for example, to include “[a-zA-Z0-9]”. The range of interval may also be narrowed such as to include “[a-c], [3-9]” and the like. Exact characters may include, for example, “@”, “.”, “-”, and the like.

In another way, a string imitation may also be utilized to generate the sample replacement value, and the string imitation can guarantee that the composition form and structure of the generated sample replacement value, is similar to the composition form and structure of the sample information value, which improves the degree of authenticity of the sample replacement value. Specifically, a regular expression of the information sample value may be generated based on the information sample value, and the designed wildcard and exact character. In order to ensure the accuracy of the string imitation, a reserved interval may be designed according to the composition form of the information sample value, i.e., characters in the reserved interval of the information sample value are not replaced, and characters in other intervals are replaced.

Taking the information sample value as “aaaaa_email.sample-7527@juli.com” as an example, considering that the mailbox suffix is fixed, “.com” may be determined as a reserved interval, and other intervals may be replaced. According to wildcard characters and exact characters, characters in other intervals in the information sample value may be replaced by imitation. For example, the first character “a” corresponds to wildcards [a-z], and so on, a regular expression “[a-z][a-z][a-z][a-z][a-z]_[a-z][a-z][a-z][a-z][a-z]\\.[a-z][a-z][a-z][a-z][a-z][a-z]\\-[0-9][0-9][0-9][0-9]@[a-z][a-z][a-z][a-z]” of the information sample value may be obtained. Further according to the regular expression, a plurality of replacement strings are generated, for example, for a first character, a character such as the character “e” may be randomly selected from [a-z] as a replacement character. For a second character, a character such as the character “s” may be randomly selected from [a-z] as a replacement character, and the replacement string “estqp_haksl.pkmylh-7425@mgwd” may be obtained by concatenating “s” after “e” to obtain the intermediate string “es”, and so on. The replacement string and the string within the reserved interval are then merged to obtain the sample replacement value, i.e. the sample replacement value “estqp_haksl.pkmylh-7425@mgwd.com”. Upon generating the sample replacement value according to the regular expression, the sample replacement value may be automatically generated by a state machine.

The present disclosure enables flexible and efficient generation of a plurality of sample replacement values by means of generating a regular expression.

In step b12, a keyword library of the target information type may be determined for each target information type. For example, based on the target semantic indicated by the target information type, keywords belonging to the target semantic may be found from the first reference data, and the keyword library of the target information type may be obtained by constructing using the found keywords.

Because the present disclosure has constructed an information template for each information sample value in the first reference data, the information template including a keyword list, it is possible to construct a keyword library of a target information type by traversing each information template in each first reference data using at least one keyword in the keyword list indicated by each information template. At least one keyword in the keyword list of each information template may be deduplicated to obtain a plurality of deduplicated keywords, and a keyword library of the target information type is constructed using the plurality of deduplicated keywords, and each keyword in the keyword library constructed after deduplication is selected at the same frequency.

Alternatively, at least one keyword of the keyword list of each information template may be used directly to construct a keyword library of the target information type. Because no deduplication is performed, there may be a plurality of the same keywords in the keyword library. The absence of the deduplication allows the selection frequency of the keywords in the keyword library to match the occurrence frequency of the keywords in the first reference data, so that when a replacement word is subsequently selected, the selection of the replacement word matches an actual situation.

The target information type corresponding to the keyword may be the target information type corresponding to the information sample value. In practice, the target information type to which the keyword belongs may be determined based on the keyword, and then a keyword may be randomly selected from a keyword library of the target information type to which it belongs as a replacement word.

In step b13, a string imitation may be utilized to generate a corresponding replacement background based on the background information. The character matching condition may include, for example, a wildcard and an exact character. In practice, for each character included in the background information, a replacement character corresponding to the character may be determined according to the determined character matching condition, and the replacement background corresponding to the background information may be generated based on each replacement character. For example, if the background information is “IADQC9FC0i”, then for the first character “I”, a wildcard [A-Z] is matched, and a character is randomly selected from [A-Z] as a replacement character, such as the replacement character “C”. Then for the second character “A”, a replacement character “F” may be obtained, the second character is spliced after the first character to get the candidate string “CF”, and so on, the replacement background may be generated.

In step b2, after obtaining the replacement information, the target template may be subjected to a replacement operation based on the replacement information to generate a plurality of sample information. The replacement part in the target template may be set as desired. For example, when replacing, the information sample value in the target template may be replaced to obtain the sample information. Alternatively, the keyword in the target template may be replaced to obtain the sample information. Alternatively, the keyword and the information sample value in the target template may be replaced to obtain sample information.

Because the sample information value is an important element in the sample information, the sample information value may be taken as a part that must be replaced in order to improve the accuracy of the sample information, so that a plurality of replacement schemes are available, i.e., a replacement scheme for information sample value, a replacement scheme for information sample value-keyword, a replacement scheme for information sample value-background information, and a replacement scheme for information sample value-keyword-background information.

The following takes the replacement scheme for information sample value-keyword-background information as an example. The information sample value in the target template may be replaced by a sample replacement value, the keyword is replaced by a replacement word, and the background information is replaced by a replacement background to obtain the sample information.

For example, for the target template “\“real_name\”:\“Zhu*qiang\”,\“phone\”:\“133****1111\”,\“encrypt_phone\”:\“#1ovL/IADQ C9FC0iCuZxGXwvBMFE0pdq70Xd1hROG1lcE4xIMElfm\”,\“Email\”:\“aaaaa_email.sampl e-7527@juli.com\”,\“Addr\”:\“bb City xx District xxxx Park Building 1 Floor 2 0000\””. A replacement may be made to the above target template to get the sample information such as “\“legal_name\”:\“Wang*jun\”,\“mobile\”:\“177****7777\”,\“phoneNumber\”:\“#7riI/JBBVH 7RO7pKrUpZAvtJVJD7aap83Yt9dFBZ6hkC6pWCQzvf\”,\“sender\”:\“AstQp_haksl.pkmylh-7425@mgwd.com\”,\“address\”:\“gg City tt District dddd Road No. xx Building 1 000-364\””.

After the sample information is obtained, labeling information for the sample information may be determined, such as the information sample value included in the sample information, the index position of the information sample value in the sample information, the target information type, the length, and the like. The labeling information of the sample information may be obtained by updating based on the labeling information corresponding to the target template.

In practice, the replacement information, the replacement scheme, can be flexibly determined according to the data type of the first reference data. For example, when the second reference data is natural text data, because the natural text data generally does not include a plurality of special characters and each word has its unambiguous semantic information, the background information may be kept unchanged and the information sample value and the keyword may be replaced to obtain the sample information. For another example, when the first reference data is buried data, considering that the buried data is mostly recorded using a JSON-format string, that is, a JSON object may be used to represent pairs of the keyword and the information sample value in the first reference data, the background information of the first reference data generally includes only special characters, and does not include letters and numeric values, so that the background information of the first reference data may be retained and only the information sample value and the keyword may be replaced to get the sample information.

For S104:
after obtaining the plurality of sample information, each sample information may be inserted into the second reference data, resulting in a sample data, the plurality of sample data constructing a sample data set. Alternatively, the sample data set may be constructed using the plurality of sample data and the first reference data.

In an alternative embodiment, generating a sample data set based on the plurality of sample information and the second reference data includes steps c1˜c3.

Step c1: for each of the second reference data, determining an insertion scheme of the second reference data based on a set proportional parameter and a random number generated for the second reference data, the insertion scheme including inserting sample information and not inserting sample information.

Step c2: when the insertion scheme of the second reference data is inserting sample information, inserting at least one sample information into the second reference data to generate sample data.

Step c3: generating the sample data set based on the sample data and second reference data with no sample information inserted.

In practice, a proportional parameter may be set such that a proportional relationship between the sample data included in the sample data set with the sample information inserted and the second reference data with no sample information inserted matches the proportional parameter. For each of the second reference data, generating a random number for the second reference data, and if the random number is greater than the scale parameter, the insertion scheme of the second reference data is determined as not inserting the sample information; if the random number is less than or equal to the proportional parameter, the insertion scheme of the second reference data is determined as inserting sample information. The proportional parameter may be set according to the requirement of sample data set construction.

When the insertion scheme of the second reference data is not inserting sample information, the second reference data is directly used as a piece of sample data in the sample data set. When the insertion scheme of the second reference data is inserting sample information, an insertion position may be determined from the second reference data, at least one sample information is selected from the plurality of sample information, and the at least one sample information is inserted into the second reference data to generate sample data. A sample data set is then constructed based on the sample data and the second reference data with no sample information inserted. In practice, a sample data set may also be constructed from the sample data, the second reference data with no sample information inserted, and the first reference data.

In an alternative embodiment, inserting at least one sample information into the second reference data to generate sample data includes: determining a sample quantity and an insertion position corresponding to the second reference data; inserting the sample quantity of sample information into the insertion position of the second reference data to generate updated second reference data, and determining labeling information of the updated second reference data, the labeling information including a target information type, an information sample value, a starting index position of the information sample value in the updated second reference data, a length of the information sample value; and determining the updated second reference data including the labeling information as sample data.

In practice, a quantity range may be set, and a positive integer may be randomly selected from the quantity range as the sample quantity corresponding to the second reference data. If the quantity range is [1, 2, 3], a positive integer such as 2 may be randomly selected as the sample quantity corresponding to the second reference data, i.e., the quantity of sample information inserted into the second reference data. Alternatively, the quantity of target templates in a real sample (e.g. any second reference data) may be determined, and the quantity is determined as the sample quantity of the second reference data.

And the insertion position may be determined from the second reference data. If the determined sample quantity is multiple, one or more insertion positions may be determined to insert sample information at each insertion position. In practice, a list of common delimiters in the second reference data may be determined, and the index position of each delimiter in the second reference data may be determined by traversing the second reference data based on the list of delimiters. The insertion position is then determined based on the index positions of the plurality of delimiters, e.g., one or more index positions of the delimiters are randomly selected as the insertion position.

After the sample quantity is determined, a sample quantity of sample information may be obtained from the plurality of sample information and inserted into the insertion position of the second reference data to generate updated second reference data. The labeling information of the updated second reference data is determined, for example, the labeling information of the updated second reference data may be generated based on the labeling information corresponding to the sample information and the index position of the insertion position. The labeling information includes a target information type, an information sample value, a starting index position of the information sample value in the updated second reference data, a length of the information sample value. The updated second reference data, including the labeling information, may then be determined as sample data.

In conjunction with FIG. 2, a general description of the specific process of the method for sample generation is given. The method includes S201˜S205.

S201, acquiring data.

A reference data set may be acquired, the reference data set including a plurality of first reference data and a plurality of second reference data.

S202, generating a short template.

For each first reference data, the first reference data may be analyzed to generate an information template (i.e. a short template) for each information sample value in the first reference data. Specifically, the information sample value in the first reference data may be analyzed to determine the keyword list corresponding to the information sample values. The information template of the information sample value is then determined based on the index information of the information sample value in the first reference data and the index information of each keyword in the keyword list corresponding to the information sample value in the first reference data. The process of determining the keyword list and the information template can be referred to the foregoing description of step a1 and step a2.

S203, generating a long template.

For each first reference data, the information templates of the plurality of information sample values in the first reference data may be subjected to a merging process to generate a target template (i.e., a long template) of the first reference data. For the specific process, please refer to the aforementioned description of step a3.

S204, constructing sample information.

The generation of the replacement information may be performed first, i.e., the generation of the sample replacement value corresponding to the information sample value, the replacement word corresponding to the keyword, and the replacement background corresponding to the background information. Then the replacement scheme is determined, such as the information sample value replacement scheme, the information sample value-keyword replacement scheme, and the like. Finally, based on the replacement scheme, the replacement operation is performed on the target template using the replacement information to generate the sample information. The specific process can be referred to the foregoing description of step b1 and step b2.

S205, constructing sample data.

For each second reference data, an insertion scheme for the second reference data is determined. If the insertion scheme is inserting sample information, a sample quantity and an insertion position of the second reference data are determined. And the sample quantity of sample information is inserted into the insertion position of the second reference data to generate updated second reference data, and labeling information of the updated second reference data is determined to obtain the sample data. The plurality of sample data constitutes a sample data set.

Considering the need to manually analyze the existence form of a specific data sample (i.e., an information sample value) in unstructured data in the related art, sample generation is performed according to the analyzed existence form, in which prior knowledge of specific data is highly dependent, and there is a risk of data leakage. Whereas the method proposed by the present disclosure, by obtaining an information template of the information sample value, a target template of the first reference data can be obtained, and the generation of the sample information is achieved through the target template, which alleviates a priori knowledge reliance on specific data, and thus alleviates the risk of data leakage and improve the efficiency of the sample generation.

And in the present scheme, by obtaining the target template, the target template can characterize the information structure of the information sample value in the first reference data, so that the structure of the sample information subsequently generated according to the target template has a high degree of fit to the target template, and the accuracy of the sample information is guaranteed while improving the sample generation efficiency. In the present scheme, after obtaining the target template, replacement information is generated, such as a replacement sample value for generating a sample value of the information, a replacement word corresponding to a keyword, and the like. The generation of sample information is achieved by replacing the target template with replacement information, which requires no manual parameters and improves the efficiency of the generation of the sample information. And the generation of the sample information for different scenarios is possible, with a high degree of ubiquity.

After obtaining the sample data set, the initial model to be trained may be trained by using the sample data set until the training cut-off condition is met, for example, the training cut-off condition may include that the number of training times being greater than a number threshold, the model converging, and the model precision being greater than a preset precision threshold, etc., and a information detection model can be generated, so that the information detection model can be deployed on a target device to realize the detection of specific information (i.e., information belonging to the target information type) in any data to be detected.

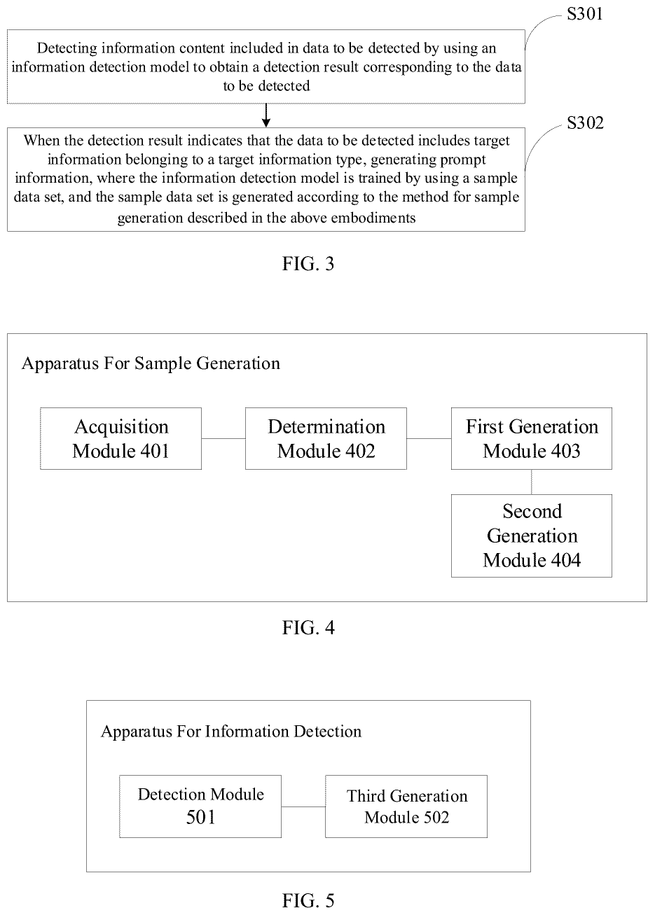

Based on the same inventive concept, FIG. 3 shows a flowchart of a method for information detection in an embodiment of the present disclosure, and the method includes S301-S302.

S301, detecting information content included in data to be detected by using an information detection model to obtain a detection result corresponding to the data to be detected.

S302, when the detection result indicates that the data to be detected includes target information belonging to a target information type, generating prompt information, where the information detection model is trained by using a sample data set, and the sample data set is generated according to the method for sample generation described in the above embodiments.

In practice, the sample data set generated by the method for sample generation described in the previous embodiment may be acquired, and the model to be trained may be trained by using the sample data set to obtain the information detection model. The information detection model is deployed on a target device, such as a server, a mobile device, etc. The information detection model is utilized to detect the information content included in the data to be detected, and the detection result corresponding to the data to be detected is obtained. If the detection result indicates that the data to be detected includes the target information belonging to the target information type, that is, the data to be detected includes the information of the information type with a security requirement, and the information cannot be leaked, so prompt information can be generated to prompt the user, alleviate the leakage of the data to be detected including the information content of the target information type, and improve data security. If the detection result indicates that the data to be detected does not include the target information belonging to the target information type, the data to be detected can be allowed to be transmitted or other operations can be performed.

Because the efficiency of the sample data set constructed by the above embodiment is high, and the sample data set includes abundant sample data, the efficiency of the information detection model obtained by training the sample data set is high, the performance of the obtained information detection model is good, and the detection result of the data to be detected can be obtained more accurately.

It can be understood by those skilled in the art that in the above-mentioned method of specific embodiments, the writing order of each step does not mean strict execution order and constitutes any limitation on the implementation process, and the specific execution order of each step should be determined according to its function and possible internal logic.

Based on the same inventive concept, the embodiment of the present disclosure further provides an apparatus for sample generation corresponding to the method for sample generation. Because the principle of solving problems by the apparatus in the embodiment of the present disclosure is similar to the above-mentioned method for sample generation in the embodiment of the present disclosure, the implementation of the apparatus can refer to the implementation of the method, which will not be repeated here.

FIG. 4 shows a schematic diagram of an apparatus for sample generation provided by an embodiment of the present disclosure, and the apparatus includes an acquisition module 401, a determination module 402, a first generation module 403 and a second generation module 404.

The acquisition module 401 is configured to acquire a reference data set, where the reference data set includes first reference data and second reference data, the first reference data includes at least one information sample value, the at least one information sample value belongs to a target information type, the target information type is a preset information type with a security requirement, and the second reference data does not include an information sample value of the target information type.

The determination module 402 is configured to determine a target template corresponding to the first reference data based on the at least one information sample value in the first reference data, the target template being used to characterize an information structure of the at least one information sample value in the first reference data.

The first generation module 403 is configured to generate a plurality of sample information based on the target template corresponding to the first reference data.

The second generation module 404 is configured to generate a sample data set based on the plurality of sample information and the second reference data.

In an optional implementation, the determination module 402, when determining a target template corresponding to the first reference data based on the at least one information sample value in the first reference data, is configured to:
analyze the at least one information sample value in the first reference data to determine a keyword list corresponding to the at least one information sample value;
according to index information of the at least one information sample value in the first reference data, and index information of each keyword in the keyword list corresponding to the at least one information sample value in the first reference data, determine an information template of the at least one information sample value; and
generate a target template corresponding to the first reference data based on the information template of the at least one information sample value.

In an optional implementation, the determination module 402, when analyzing the at least one information sample value in the first reference data to determine a keyword list corresponding to the at least one information sample value, is configured to:
determine a search interval corresponding to the at least one information sample value based on index information of the at least one information sample value in the first reference data and a set search length threshold; and
determine a keyword list corresponding to the at least one information sample value from the search interval corresponding to the at least one information sample value using a preset word library matching a target information type to which the at least one information sample value belongs.

In an optional implementation, the determination module 402 is configured to generate the preset word library matching the target information type according to following steps:
based on a target semantic indicated by the target information type, acquiring a target word of the target semantic;
based on the target word, generating a compound word including the target word;
based on the target word, constructing a misspelled word of the target word; and
based on the target word, the compound word and the misspelled word, generating the preset word library matching the target information type.

In an optional implementation, when the first reference data includes a plurality of information sample values, the determination module 402, when generating a target template corresponding to the first reference data based on the information template of the at least one information sample value, is configured to:
based on index information of each of a plurality of information templates in the first reference data, sort the plurality of information templates; and
according to a preset gap threshold, perform merging processing on the sorted plurality of information templates to generate a target template corresponding to the first reference data.

In an optional implementation, the determining module 402, when according to a preset gap threshold, performing merging processing on the sorted plurality of information templates to generate a target template corresponding to the first reference data, is configured to:
based on index information of the plurality of information templates in the first reference data, determine a gap length between every two adjacent information templates in the sorted plurality of information templates;
perform merging processing on a plurality of information templates with a gap length smaller than the preset gap threshold to generate a processed information template; and
when an unprocessed information template exists in the plurality of information templates, generate a target template corresponding to the first reference data based on the processed information template and the unprocessed information template.

In an optional implementation, when the target template includes an information sample value, a keyword, and background information, the first generation module 403, when generating a plurality of sample information based on the target template corresponding to the first reference data, is configured to:
generate replacement information corresponding to the target template, the replacement information including at least one of a sample replacement value corresponding to the information sample value, a replacement word corresponding to the keyword, and a replacement background corresponding to the background information; and
based on the replacement information, perform a replacement operation on the target template to generate a plurality of sample information.

In an optional implementation, the first generation module 403, when generating replacement information corresponding to the target template, is configured to:
when the replacement information includes the sample replacement value corresponding to the information sample value, based on the information sample value included in the target template, construct a regular expression satisfying a composition form of the information sample value; and based on the regular expression, generate the sample replacement value;
when the replacement information includes the replacement word corresponding to the keyword, acquire the replacement word corresponding to the keyword from the keyword library of a target information type corresponding to the keyword, the keyword library being constructed by finding keywords from the first reference data based on semantic information indicated by the target information type;
when the replacement information includes the replacement background corresponding to the background information, for each character included in the background information, determine a replacement character corresponding to the character based on a determined character matching condition, and generating the replacement background corresponding to the background information based on each replacement character.

In an optional implementation, the second generation module 404, when generating a sample data set based on the plurality of sample information and the second reference data, is configured to:
for each of the second reference data, determine an insertion scheme of the second reference data based on a set proportional parameter and a random number generated for the second reference data, the insertion scheme including inserting sample information and not inserting sample information;
when the insertion scheme of the second reference data is inserting sample information, insert at least one sample information into the second reference data to generate sample data; and
generate the sample data set based on the sample data and second reference data with no sample information inserted.

In an optional implementation, the second generation module 404, when inserting at least one sample information into the second reference data to generate sample data, is configured to:
determine a sample quantity and an insertion position corresponding to the second reference data;
insert the sample quantity of sample information into the insertion position of the second reference data to generate updated second reference data, and determine labeling information of the updated second reference data, the labeling information including a target information type, an information sample value, a starting index position of the information sample value in the updated second reference data, a length of the information sample value; and
determine the updated second reference data including the labeling information as sample data.

FIG. 5 shows a schematic diagram of an apparatus for information detection provided by an embodiment of the present disclosure, and the apparatus includes a detection module 501 and a third generation module 502.

The detection module 501 is configured to detect information content included in data to be detected by using an information detection model to obtain a detection result corresponding to the data to be detected.

The third generation module 502 is configured to, when the detection result indicates that the data to be detected includes target information belonging to a target information type, generate prompt information,
where the information detection model is trained by using a sample data set, and the sample data set is generated according to the method for sample generation provided by at least one embodiment of the present disclosure.

The description of the process flow of a plurality of modules in the apparatus, and the interaction flow between the plurality of modules can refer to the related description in the above method embodiments, which will not be detailed here.

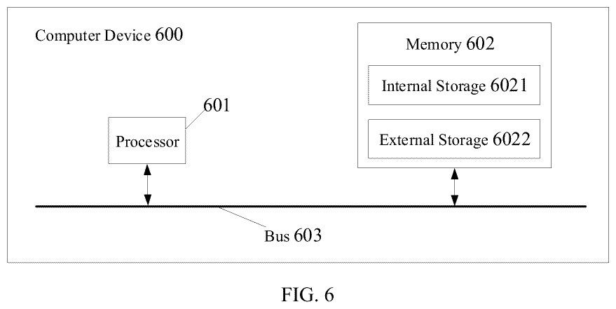

Based on the same technical concept, the embodiment of the present disclosure further provides a computer device. Referring to FIG. 6, FIG. 6 is a structural schematic diagram of a computer device 600 provided by an embodiment of the present disclosure includes at least one processor 601, a memory 602, and a bus 603. The memory 602 is used to store executable instructions, including an internal storage 6021 and an external storage 6022. The internal storage 6021, also called an internal memory, is used for temporarily storing operation data in the processor 601 and data exchanged with the external storage 6022 such as a hard disk. The processor 601 exchanges data with the external storage 6022 through the internal storage 6021; when the computer device 600 runs, the processor 601 communicates with the memory 602 through the bus 603, causing the processor 601 to execute the following instructions:
acquiring a reference data set, where the reference data set includes first reference data and second reference data, the first reference data includes at least one information sample value, the at least one information sample value belongs to a target information type, the target information type is a preset information type with a security requirement, and the second reference data does not include an information sample value of the target information type;
determining a target template corresponding to the first reference data based on the at least one information sample value in the first reference data, the target template being used to characterize an information structure of the at least one information sample value in the first reference data;
generating a plurality of sample information based on the target template corresponding to the first reference data; and
generating a sample data set based on the plurality of sample information and the second reference data.

Or the processor 601 executes the following instructions:
detecting information content included in data to be detected by using an information detection model to obtain a detection result corresponding to the data to be detected; and
when the detection result indicates that the data to be detected includes target information belonging to a target information type, generating prompt information, where the information detection model is trained by using a sample data set, and the sample data set is generated according to the method for sample generation described in the above embodiments.

An embodiment of the present disclosure further provides a computer-readable storage medium storing computer programs, and the computer programs upon being run by at least one processor, execute the steps of the method for sample generation and the method for information detection described in the above method embodiment. The storage medium may be a volatile or nonvolatile computer-readable storage medium.

An embodiment of the present disclosure further provides a computer program product carrying program codes, the program codes including instructions that can be used to execute the steps of the method for sample generation and the method for information detection described in the above-mentioned method embodiment. For details, please refer to the above-mentioned method embodiment, and the details are not repeated here.

The computer program product may be specifically implemented by hardware, software or a combination thereof. In one alternative embodiment, the computer program product is embodied as a computer storage medium, and in another alternative embodiment, the computer program product is embodied as a software product, such as a software development kit (SDK) and the like.

It can be clearly understood by those skilled in the art that, for convenience and simplicity of description, specific working processes of the system and the apparatus described above may refer to the corresponding processes in the foregoing method embodiment, which are omitted here. In the several embodiments provided in the present disclosure, it is to be understood that the disclosed system, apparatus, and method may be implemented in other manners. The above-described apparatus embodiments are merely illustrative. For example, the division of the units may be merely a logical function division, and in actual implementation, there may be another division mode. For another example, multiple units or components may be combined or integrated into another system, or some features may be omitted, or may not be executed. In addition, the displayed or discussed mutual couplings or direct couplings or communication connections may be implemented through some communication interfaces. The indirect couplings or communication connections between the apparatuses or units may be implemented in electronic, mechanical, or other forms.

The units described as separate parts may or may not be physically separate, and the components displayed as units may or may not be physical units, that is, they may be located in one position, or may be distributed on a plurality of network units. Some or all of the units may be selected according to actual needs to achieve the purposes of the solutions of the embodiments.

In addition, functional units in the embodiments of the present disclosure may be integrated into one processing unit, or each unit may exist alone physically, or two or more units may be integrated into one unit.

The functions, if implemented in software functional units and sold or used as a stand-alone product, may be stored in a nonvolatile computer-readable storage medium executable by a processor. Based on such understanding, the technical solutions of the present disclosure, which are essential or part of the technical solutions contributing to the related art, may be embodied in the form of a software product, which software product is stored in a storage medium and includes several instructions for causing a computer device (which may be a personal computer, a server, or a network device, etc.) to execute all or part of the steps of the methods described in the embodiments of the present disclosure. The aforementioned storage medium includes a U disk, a mobile hard disk, a read-only memory (ROM), a random access memory (RAM), a magnetic disk or an optical disk and other media that can store program codes.

Finally, it should be noted that the above-mentioned embodiments are merely specific embodiments of the present disclosure, which are used to illustrate the technical solutions of the present disclosure, but not to limit the technical solutions, and the scope of protection of present disclosure is not limited thereto. Although the present disclosure is described in detail with reference to the foregoing embodiments, those of ordinary skill in the art should understand that any person familiar with the art can still make modifications or changes to the embodiments described in the foregoing embodiments, or make equivalent replacements for some of the technical features, within the technical scope of the present disclosure; and such modifications, changes or replacements do not make the essence of the corresponding technical solution deviate from the spirit and scope of the technical solutions of the embodiments of the present disclosure, and should be included in the scope of protection of the present disclosure. Therefore, the scope of protection of the present disclosure shall be subject to the scope of protection of the appended claims.

1. A method for sample generation, comprising:
acquiring a reference data set, wherein the reference data set comprises first reference data and second reference data, the first reference data comprises at least one information sample value, the at least one information sample value belongs to a target information type, the target information type is a preset information type with a security requirement, and the second reference data does not comprise an information sample value of the target information type;
determining a target template corresponding to the first reference data based on the at least one information sample value in the first reference data, wherein the target template is used to characterize an information structure of the at least one information sample value in the first reference data;
generating a plurality of sample information based on the target template corresponding to the first reference data; and
generating a sample data set based on the plurality of sample information and the second reference data.

2. The method according to claim 1, wherein the determining a target template corresponding to the first reference data based on the at least one information sample value in the first reference data comprises:
analyzing the at least one information sample value in the first reference data to determine a keyword list corresponding to the at least one information sample value;
according to index information of the at least one information sample value in the first reference data, and index information of each keyword in the keyword list corresponding to the at least one information sample value in the first reference data, determining an information template of the at least one information sample value; and
generating a target template corresponding to the first reference data based on the information template of the at least one information sample value.

3. The method according to claim 2, wherein the analyzing the at least one information sample value in the first reference data to determine a keyword list corresponding to the at least one information sample value comprises:
determining a search interval corresponding to the at least one information sample value based on index information of the at least one information sample value in the first reference data and a set search length threshold; and
determining a keyword list corresponding to the at least one information sample value from the search interval corresponding to the at least one information sample value using a preset word library matching a target information type to which the at least one information sample value belongs.

4. The method according to claim 3, wherein the preset word library matching the target information type is generated according to following steps:
based on a target semantic indicated by the target information type, acquiring a target word of the target semantic;
based on the target word, generating a compound word comprising the target word;
based on the target word, constructing a misspelled word of the target word; and
based on the target word, the compound word and the misspelled word, generating the preset word library matching the target information type.

5. The method according to claim 2, wherein when the first reference data comprises a plurality of information sample values, the generating a target template corresponding to the first reference data based on the information template of the at least one information sample value comprises:
based on index information of each of a plurality of information templates in the first reference data, sorting the plurality of information templates; and
according to a preset gap threshold, performing merging processing on a sorted plurality of information templates to generate a target template corresponding to the first reference data.

6. The method according to claim 5, wherein the according to a preset gap threshold, performing merging processing on the sorted plurality of information templates to generate a target template corresponding to the first reference data comprises:
based on index information of the plurality of information templates in the first reference data, determining a gap length between every two adjacent information templates in the sorted plurality of information templates;
performing merging processing on a plurality of information templates with a gap length smaller than the preset gap threshold to generate a processed information template; and
when an unprocessed information template exists in the plurality of information templates, generating a target template corresponding to the first reference data based on the processed information template and the unprocessed information template.

7. The method according to claim 1, wherein when the target template comprises an information sample value, a keyword, and background information, the generating a plurality of sample information based on the target template corresponding to the first reference data comprises:
generating replacement information corresponding to the target template, the replacement information comprising at least one selected from a group consisting of a sample replacement value corresponding to the information sample value, a replacement word corresponding to the keyword, and a replacement background corresponding to the background information; and
based on the replacement information, performing a replacement operation on the target template to generate a plurality of sample information.

8. The method according to claim 7, wherein the generating replacement information corresponding to the target template comprises:
when the replacement information comprises the sample replacement value corresponding to the information sample value, based on the information sample value comprised in the target template, constructing a regular expression satisfying a composition form of the information sample value; and based on the regular expression, generating the sample replacement value;
when the replacement information comprises the replacement word corresponding to the keyword, acquiring the replacement word corresponding to the keyword from the keyword library of a target information type corresponding to the keyword, wherein the keyword library is constructed by finding keywords from the first reference data based on semantic information indicated by the target information type; and
when the replacement information comprises the replacement background corresponding to the background information, for each character comprised in the background information, determining a replacement character corresponding to the character based on a determined character matching condition, and generating the replacement background corresponding to the background information based on each replacement character.

9. The method according to claim 1, wherein the generating a sample data set based on the plurality of sample information and the second reference data comprises:
for each of the second reference data, determining an insertion scheme of the second reference data based on a set proportional parameter and a random number generated for the second reference data, wherein the insertion scheme comprises inserting sample information and not inserting sample information;
when the insertion scheme of the second reference data is inserting sample information, inserting at least one sample information into the second reference data to generate sample data; and
generating the sample data set based on the sample data and second reference data with no sample information inserted.

10. The method according to claim 9, wherein the inserting at least one sample information into the second reference data to generate sample data comprises:
determining a sample quantity and an insertion position corresponding to the second reference data;
inserting the sample quantity of sample information into the insertion position of the second reference data to generate updated second reference data, and determining labeling information of the updated second reference data, wherein the labeling information comprises a target information type, an information sample value, a starting index position of the information sample value in the updated second reference data, a length of the information sample value; and
determining the updated second reference data comprising the labeling information as sample data.

11. The method according to claim 1, wherein the sample data set generated according to the method is used to train an information detection model, the information detection model is used to detect information content comprised in data to be detected to obtain a detection result corresponding to the data to be detected, and when the detection result indicates that the data to be detected comprises target information belonging to a target information type, prompt information is generated.

12. A computer device comprising:
at least one processor, a memory and a bus, wherein the memory stores machine-readable instructions executable by the at least one processor; the at least one processor communicates with the memory through the bus upon running of the computer device, and the machine-readable instructions, upon being executed by the at least one processor, execute a method for sample generation, and the method comprises:
acquiring a reference data set, wherein the reference data set comprises first reference data and second reference data, the first reference data comprises at least one information sample value, the at least one information sample value belongs to a target information type, the target information type is a preset information type with a security requirement, and the second reference data does not comprise an information sample value of the target information type;
determining a target template corresponding to the first reference data based on the at least one information sample value in the first reference data, wherein the target template is used to characterize an information structure of the at least one information sample value in the first reference data;
generating a plurality of sample information based on the target template corresponding to the first reference data; and
generating a sample data set based on the plurality of sample information and the second reference data.

13. The computer device according to claim 12, wherein the determining a target template corresponding to the first reference data based on the at least one information sample value in the first reference data comprises:
analyzing the at least one information sample value in the first reference data to determine a keyword list corresponding to the at least one information sample value;
according to index information of the at least one information sample value in the first reference data, and index information of each keyword in the keyword list corresponding to the at least one information sample value in the first reference data, determining an information template of the at least one information sample value; and
generating a target template corresponding to the first reference data based on the information template of the at least one information sample value.

14. The computer device according to claim 13, wherein the analyzing the at least one information sample value in the first reference data to determine a keyword list corresponding to the at least one information sample value comprises:
determining a search interval corresponding to the at least one information sample value based on index information of the at least one information sample value in the first reference data and a set search length threshold; and
determining a keyword list corresponding to the at least one information sample value from the search interval corresponding to the at least one information sample value using a preset word library matching a target information type to which the at least one information sample value belongs.

15. The computer device according to claim 14, wherein the preset word library matching the target information type is generated according to following steps:
based on a target semantic indicated by the target information type, acquiring a target word of the target semantic;
based on the target word, generating a compound word comprising the target word;
based on the target word, constructing a misspelled word of the target word; and
based on the target word, the compound word and the misspelled word, generating the preset word library matching the target information type.

16. The computer device according to claim 13, wherein when the first reference data comprises a plurality of information sample values, the generating a target template corresponding to the first reference data based on the information template of the at least one information sample value comprises:
based on index information of each of a plurality of information templates in the first reference data, sorting the plurality of information templates; and
according to a preset gap threshold, performing merging processing on a sorted plurality of information templates to generate a target template corresponding to the first reference data.

17. The computer device according to claim 16, wherein the according to a preset gap threshold, performing merging processing on the sorted plurality of information templates to generate a target template corresponding to the first reference data comprises:
based on index information of the plurality of information templates in the first reference data, determining a gap length between every two adjacent information templates in the sorted plurality of information templates;
performing merging processing on a plurality of information templates with a gap length smaller than the preset gap threshold to generate a processed information template; and
when an unprocessed information template exists in the plurality of information templates, generating a target template corresponding to the first reference data based on the processed information template and the unprocessed information template.

18. The computer device according to claim 12, wherein when the target template comprises an information sample value, a keyword, and background information, the generating a plurality of sample information based on the target template corresponding to the first reference data comprises:
generating replacement information corresponding to the target template, the replacement information comprising at least one selected from a group consisting of a sample replacement value corresponding to the information sample value, a replacement word corresponding to the keyword, and a replacement background corresponding to the background information; and
based on the replacement information, performing a replacement operation on the target template to generate a plurality of sample information.

19. The computer device according to claim 18, wherein the generating replacement information corresponding to the target template comprises:
when the replacement information comprises the sample replacement value corresponding to the information sample value, based on the information sample value comprised in the target template, constructing a regular expression satisfying a composition form of the information sample value; and based on the regular expression, generating the sample replacement value;
when the replacement information comprises the replacement word corresponding to the keyword, acquiring the replacement word corresponding to the keyword from the keyword library of a target information type corresponding to the keyword, wherein the keyword library is constructed by finding keywords from the first reference data based on semantic information indicated by the target information type; and
when the replacement information comprises the replacement background corresponding to the background information, for each character comprised in the background information, determining a replacement character corresponding to the character based on a determined character matching condition, and generating the replacement background corresponding to the background information based on each replacement character.

20. A non-transient computer-readable storage medium storing computer programs, wherein the computer programs, upon being run by at least one processor, execute a method for sample generation, and the method comprises:
acquiring a reference data set, wherein the reference data set comprises first reference data and second reference data, the first reference data comprises at least one information sample value, the at least one information sample value belongs to a target information type, the target information type is a preset information type with a security requirement, and the second reference data does not comprise an information sample value of the target information type;
determining a target template corresponding to the first reference data based on the at least one information sample value in the first reference data, wherein the target template is used to characterize an information structure of the at least one information sample value in the first reference data;
generating a plurality of sample information based on the target template corresponding to the first reference data; and
generating a sample data set based on the plurality of sample information and the second reference data.
